(19) United States
(12) Patent Application Publication
(10) Pub. No.: US 2007/0234856 A1
(43) Pub. Date: Oct. 11, 2007

(54) Magnetic connecting tube for a screwdriver head

(76) Inventor: Kuo-Chen Liu, Ta Li (TW)

Correspondence Address: KUO-HSIUNG CHIU, 13F., NO.23, JIUN-HO STREET, PEITUN DISTRICT, TAICHUNG, 406, TW

(21) Appl. No.: 11/397,391

(22) Filed: Apr. 5, 2006

(51) Int. Cl. B25B 23/00; B25B 23/10; B25B 23/08

(52) U.S. Cl. 81/438; 81/451

(57) ABSTRACT

A magnetic connecting tube for a screwdriver head including a main body, a push sleeve, an engaging piece, a compression ball, a blocking ring, a spring element, a polygonal bar, an stationary magnet, and a mobile magnet. A slide sleeve is mounted on the mobile magnet that is synchronically movable with the slide sleeve. The slide sleeve is disposed at a position corresponding to that of the compression ball. Moreover, the slide sleeve includes an axial guide slot with a deep top and a shallow bottom. In this way, the movement of the mobile magnet can be restricted by the interaction of the compression ball and the spring element. Meanwhile, it is easy to complete the initial process of the insertion of the polygonal screwdriver bit without moving the push sleeve. Accordingly, a simple operation can be ensured.

### BACKGROUND OF THE INVENTION

1. Fields of the Invention

The invention relates to a magnetic connecting tube for a screwdriver head, and more particularly, to a configuration through which the polygonal screwdriver bit can be easily inserted in place without moving a push sleeve, thereby ensuring an easy operation.

2. Description of the Related Art

As shown in FIGS. 5 through 7, a conventional magnetic connecting tube for a screwdriver head is disclosed in U.S. Pat. No. 6,666,114. The conventional magnetic connecting tube for a screwdriver head includes a main body 10. Two permanent magnets 12, 13 with opposing magnetism are positioned within a receiving hole 111 of the main body 10 for attracting a polygonal screwdriver bit 14 (to avoid the escape thereof from the receiving hole 11 of the main body 10) as well as allowing an automatic ejecting action of the polygonal screwdriver bit 14 for an easy replacement. As a result, this conventional magnetic connecting tube for a screwdriver head wins a wide popularity.

However, in feeding or removing the polygonal screwdriver bit 14, a push sleeve 15 has to be moved firstly for disengaging an engaging piece 16 from its engagement position. In this way, the polygonal screwdriver bit 14 can be smoothly forced into the receiving hole 11 of the main body 10, or the polygonal screwdriver bit 14 can be disengaged from the corresponding indentation 141 by the engaging piece 16. As a result, the easy operation and the convenient use of this configuration are slightly affected. This is required to be improved.

### SUMMARY OF THE INVENTION

It is a primary object of the invention is to provide a magnetic connecting tube for a screwdriver head that can eliminate the aforementioned drawbacks and ensure the easy operation as well as the convenient use.

In order to achieve the above-mentioned object, the magnetic connecting tube for a screwdriver head includes a slide sleeve is mounted on the mobile magnet that is synchronically movable with the slide sleeve. The slide sleeve is disposed at a position corresponding to that of the compression ball. Moreover, the slide sleeve includes an axial guide. In this way, it is easy to complete the initial process of the insertion of the polygonal screwdriver bit without moving the push sleeve. Accordingly, a simple operation can be ensured.

### BRIEF DESCRIPTION OF THE DRAWINGS

The accomplishment of this and other objects of the invention will become apparent from the following description and its accompanying drawings of which:

FIG. 1 is a perspective exploded view of a preferred embodiment of the invention;

FIG. 2 is a cutaway view of the assembled embodiment of the invention according to FIG. 1;

FIG. 3 is a cutaway view of the invention according to FIG. 2, showing the action in inserting a polygonal screwdriver bit;

FIG. 4 is a cutaway view of the invention according to FIG. 3, showing the action in forcing the polygonal screwdriver bit in an engaged position;

FIG. 5 is a perspective exploded view of a prior art according to U.S. Pat. No. 6,666,114;

FIG. 6 is a cutaway view of the prior art according to FIG. 5, showing a polygonal screwdriver bit in an engaged position; and

FIG. 7 is a cutaway view of the prior art according to FIG. 5, showing a polygonal screwdriver bit in a released position.

### DETAILED DESCRIPTION OF THE PREFERRED EMBODIMENT

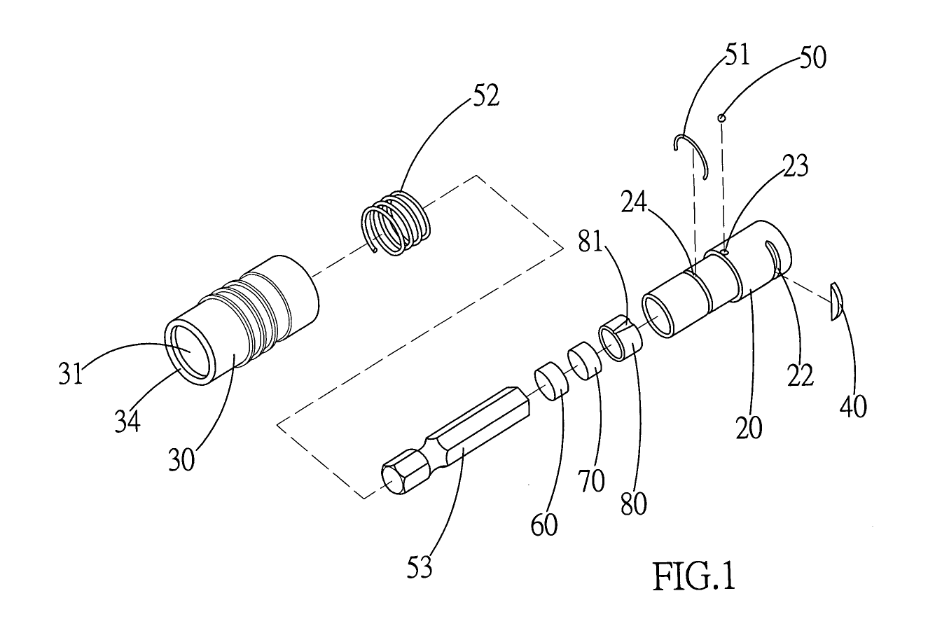

Referring to FIGS. 1 through 3, a preferred embodiment of the invention includes a main body 20, a push sleeve 30, an engaging piece 40, a compression ball 50, a blocking ring 51, a spring element 52, a polygonal bar 53, an stationary magnet 60, and a mobile magnet 70.

The main body 20 is a stage-shaped cylindrical tube with one end in connection with the polygonal bar 53 and with the other end in shape of polygonal hole 21 for receiving a polygonal screwdriver bit 90. A slot 22 and a ball hole 23 are formed at the periphery of the polygonal hole 21 for receiving the engaging piece 40 and the compression ball 50. The slot 22 and the ball hole 23 join the polygonal hole 21. Moreover, an annular groove 24 is formed in close vicinity to the distal end of the main body 20 for receiving the blocking ring 51.

The push sleeve 30 is mounted on the main body 20. The push sleeve 30 has a cavity 31 with an arched groove 32 and an internal ring groove 33 on the wall of the cavity 31 corresponding to the slot 22 and the ball hole 23 of the main body 20, respectively. The distal end of the push sleeve 30 includes a blocking ring 34 on which a spring element 52 is supported.

The engaging piece 40 is engageable in the slot 22 of the main body 20 for exerting in cooperation with the push sleeve 30 and its arched groove 32 an engaging effect on an indentation 91 of the polygonal screwdriver bit 90.

The spring element 52 is interposed between the main body 20 and the push sleeve 30.

The stationary magnet 60 is fixed at the bottom of the polygonal hole 21 of the main body 20 and has a magnetism opposing to that of the mobile magnet 70.

The mobile magnet 70 is movably disposed within the polygonal hole 21 of the main body 20 and creates a repelling force against that of the mobile magnet 70.

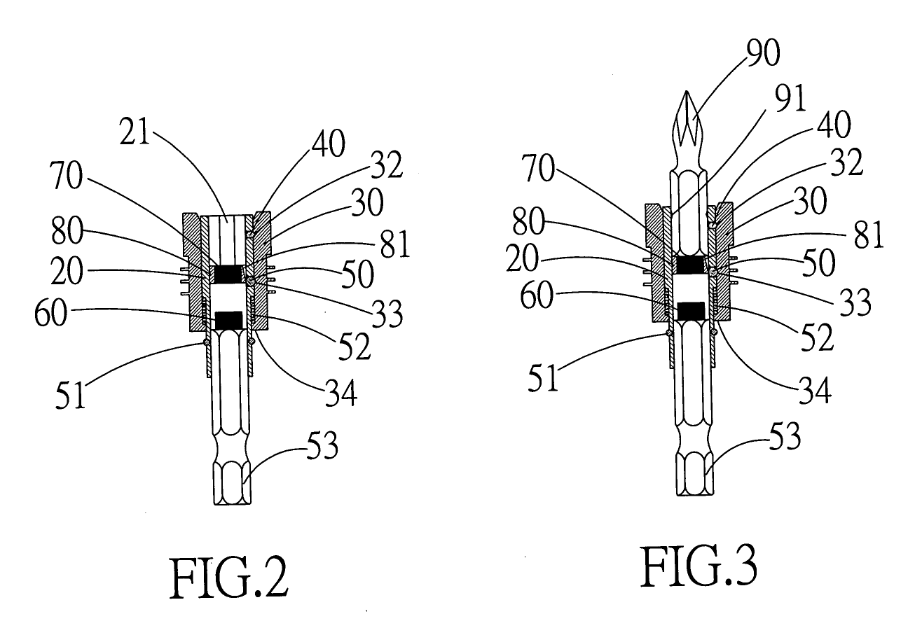

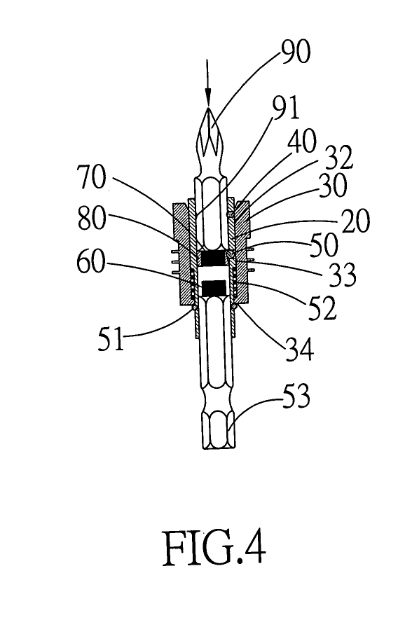

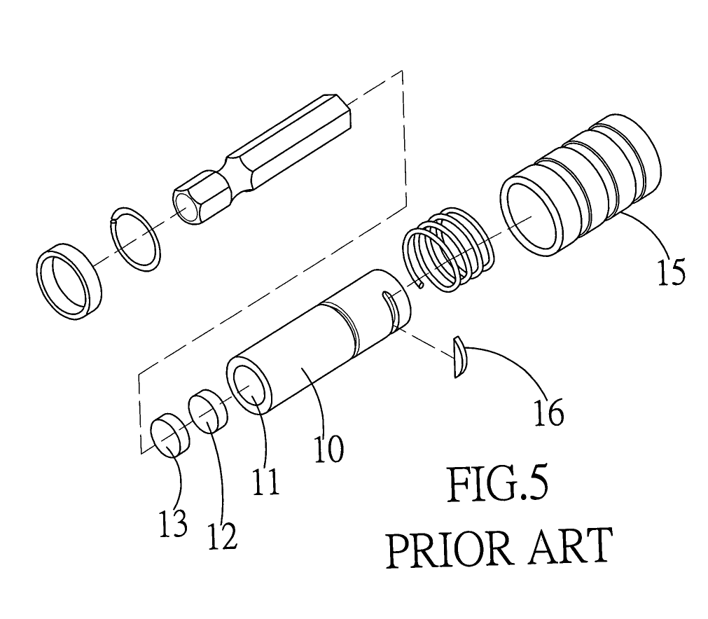

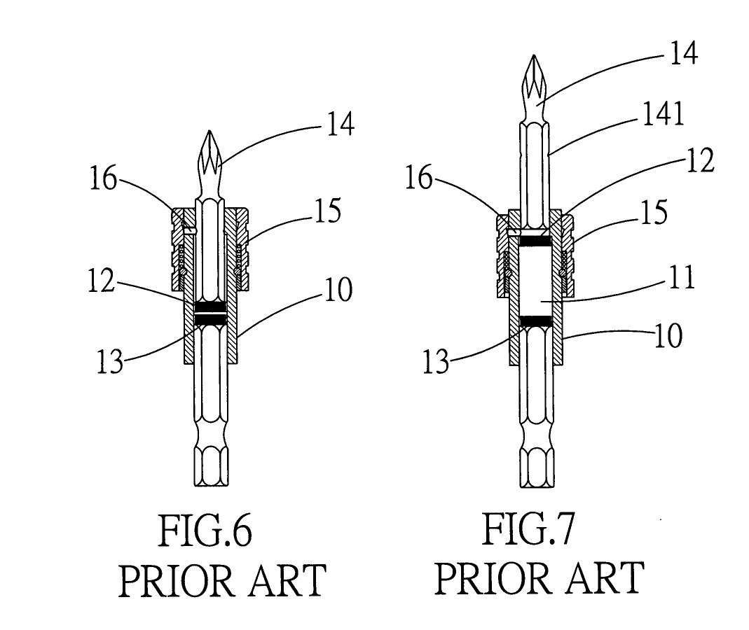

A slide sleeve 80 is mounted on the mobile magnet 70 that is synchronically movable with the slide sleeve 80. The slide sleeve is disposed at a position corresponding to that of the compression ball. Moreover, the slide sleeve 80 includes an axial guide slot 81 with a deep top and a shallow bottom. In this way, the mobile magnet 70 is located under the expelling force created by the stationary magnet 60 in an upwards floating position in the ordinary state, as shown in FIG. 2. At this time, the push sleeve 30 is fixed in place by the compression ball 50 while the engaging piece 40 is located at a released position. As a result, it has no problem to insert a polygonal screwdriver bit 90 into the polygonal hole 21 of the main body 20. In forcing the polygonal screwdriver bit 90 into the polygonal hole 21 of the main body 20, as shown in FIG. 3, the polygonal screwdriver bit 90 will be attracted by the mobile magnet 70 without worrying about the polygonal screwdriver bit 90 falling down to the ground. In applying, only a slight force to the polygonal screwdriver bit 90, the mobile magnet 70 together with the slide sleeve 80 can be compressed downwardly by the polygonal screwdriver bit 90, as shown in FIG. 4. In this way, the compression ball 50 is released along the axial guide slot 81. At that time, the push sleeve 30 will be pushed downwardly by the resilient force of the spring element 52 so as to engage the engaging piece 40 into the arched groove 32. Meanwhile, the other end of the engaging piece 40 just fits into the indentation 91 of the polygonal screwdriver bit 90, thereby fixing the polygonal screwdriver bit 90. Accordingly, the polygonal screwdriver bit 90 cannot be easily pulled out.

In removing the polygonal screwdriver bit 90, it is only required to push the push sleeve 30 upwards such that the engaging piece 40 is disengaged from the arched groove 32. In this way, the polygonal screwdriver bit 90 can be easily removed. At the same time of removing the polygonal screwdriver bit 90, the mobile magnet 70 and the slide sleeve 80 return to the upward floating position (normal position), as shown in FIG. 2. Accordingly, it is ready again to receive a polygonal screwdriver bit 90.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claim.

What is claimed is:

1. A magnetic connecting tube for a screwdriver head, comprising:
a) a main body being a stage-shaped cylindrical tube with one end in connection with the polygonal bar and with the other end in shape of a polygonal hole, a slot and a ball hole being formed at the periphery of the polygonal hole, the slot and the ball hole joining the polygonal hole, an annular groove being formed in close vicinity to the distal end of the main body;
b) a push sleeve having a cavity with an arched groove and an internal ring groove on the wall of the cavity, the distal end of the push sleeve having a blocking ring;
c) an engaging piece engageable in the slot of the main body for exerting in cooperation with the push sleeve and the arched groove an engaging effect on an indentation of a polygonal screwdriver bit;
d) a compression ball;
e) a blocking ring;
f) a spring element interposed between the main body and the push sleeve;
g) a polygonal bar;
h) A stationary magnet fixed at the bottom of the polygonal hole of the main body with a magnetism opposing to that of the mobile magnet;
i) a mobile magnet movably disposed within the polygonal hole of the main body with a repelling force against that of the mobile magnet; and
j) a slide sleeve mounted on the mobile magnet that is synchronically movable with the slide sleeve, the slide sleeve being disposed at a position corresponding to that of the compression ball, the slide sleeve having an axial guide slot with a deep top and a shallow bottom
whereby, the mobile magnet is located under the expelling force created by the stationary magnet in an upwards floating position in the ordinary state; at this time, the push sleeve is fixed in place by the compression ball while the engaging piece 40 is located at a released position such that it has no problem to insert a polygonal screwdriver bit into the polygonal hole of the main body; in applying only a slight force to the polygonal screwdriver bit, the mobile magnet together with the slide sleeve can be compressed downwardly by the polygonal screwdriver bit; meanwhile, the compression ball is released along the axial guide slot; at that time, the push sleeve will be pushed downwardly by the resilient force of the spring element so as to engage the engaging piece into the arched groove; moreover, the other end of the engaging piece just fits into the indentation of the polygonal screwdriver bit, thereby fixing the polygonal screwdriver bit in place without being pulled out.
